(19) United States
(12) Patent Application Publication
(10) Pub. No.: US 2018/0247050 A1
(43) Pub. Date: Aug. 30, 2018

(54) SYSTEM AND METHOD FOR MANAGING PASSWORD FOR A PHYSICAL OBJECT ON AN INTERACTIVE BOARD

(71) Applicants: Zheng Shi, Beijing (CN); Huihui Wang, Beijing (CN)

(72) Inventors: Zheng Shi, Beijing (CN); Huihui Wang, Beijing (CN)

(21) Appl. No.: 15/964,060

(22) Filed: Apr. 26, 2018

Related U.S. Application Data
(63) Continuation-in-part of application No. PCT/CN2016/072095, filed on Jan. 26, 2016.

(30) Foreign Application Priority Data
Oct. 28, 2015 (CN) 2015107163254

(51) Int. Cl. G06F 21/45; G06F 21/31

(52) U.S. Cl. CPC G06F 21/45; G06F 21/31

(57) ABSTRACT

A system and method is provided for password management for a physical object on the interactive board. The system includes a plurality of physical objects, each associated with an ID, an interactive board that comprises a processor, and a password management program that is connected with the processor. The physical objects are placed on the interactive board, which recognizes the ID, and a user sets password to the physical objects through the password management program. The system and the accompanying method provided in the present invention enhance the safety of the device and meet the personalized demand of users.

### CROSS-REFERENCE TO RELATED APPLICATION

This application is a continuation in part of International Patent Application No. PCT/CN2016/072095, entitled “System and Method for Managing Password for a Physical Object on an Interactive Board”, filed on Jan. 26, 2016, which claims priority of Patent Application No. CN2015107163254, entitled “A System for Managing Password for a Physical Object on an Interactive Board”, filed on Oct. 28, 2015. The entire disclosure of the above application is incorporated herein by reference.

### TECHNICAL FIELD

The present invention relates to the field of password management, particularly to system and method for managing password for a physical object on an interactive board.

### BACKGROUND

To date, graphical user interfaces have been applied in the commercial systems developed by Apple, Microsoft and Sun Microsystems, so that users can interact with computers naturally. In practice, however, it is more satisfactory if users interact with computers through physical objects. For example, in some interactive games, people interact with physical objects by touching and physical perception, which increases the fun of the game. For another instance, it is easier for children to be fully engaged in language learning when they interact with computers by manipulating physical objects, compared to by using graphical user interfaces.

The application of password managing system on intelligent terminals may enhance a user's experience. In order that the user's experience of interacting with computers by manipulating physical objects is enhanced, it is necessary to provide a system for managing password for a physical object on an interactive board.

### SUMMARY OF THE INVENTION

Aiming to solve the problems above, the present invention provides a system for managing password for a physical object on an interactive board, which enhances the safety of the device and meets the personalized demand of users.

The system for managing password for a physical object on an interactive board includes a plurality of physical objects, each associated with an ID that is recognized by the interactive board upon the physical object having been placed on the interactive board, a processor that is operatively linked to the interactive board, and a password management program that runs on the processor and manages password corresponding to an ID of a physical object. Once a user selects a physical object among a plurality of physical objects on the interactive board and sets a password for the physical object, the processor is configured to instruct the program to record the relationship between the ID of the physical object and the password.

Further, the ID is embedded in a passive RFID tag.

Further, the interactive board includes an electrode array that comprises at least one electrode, and an RF antenna array that comprises at least one RF antenna.

Further, the user selects a physical object by a touch gesture or by a voice command.

Further, the user sets the password through touch gestures on the interactive board, keys entered on the interactive board, or voice commands.

Further, once a user reproduces the correct password, the processor is configured to activate a functional attribute of the physical object.

Further, the physical object can be a token, an icon, a card, a figurine, or a robot.

Further, the password management program further comprises the functionality of changing password and recovering password.

Further, the system for managing password further includes a feedback device, and the processor is configured to instruct the feedback device to produce a feedback to indicate whether a user has reproduced the password correctly or not.

The present invention provides a system and the accompanying method for managing password for a physical object on the interactive board, which improves the safety of the device and meets the personalized demand of users.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are only for exemplary embodiments of the present invention, and that a person of ordinary skill in the art may derive additional drawings without deviating from the principles of the present invention.

FIG. 1 is an exemplary schematic diagram illustrating the system for managing password for a physical object on an interactive board in accordance with one embodiment of the present invention.

FIG. 2 is an exemplary schematic diagram illustrating the working process of a system for managing password for a physical object on the interactive board in accordance with one embodiment of the present invention.

FIG. 3 is an exemplary schematic diagram illustrating the system for managing password in which the physical object is a robot in accordance with one embodiment of the present invention.

### DETAILED DESCRIPTION OF THE INVENTION

To better illustrate the purpose, technical feature, and advantages of the embodiments of the present invention, various embodiments of the present invention will be further described in conjunction with the accompanying drawings.

While the present invention will be described in connection with various specific embodiments, the invention is not limited to these embodiments. People skilled in the art will recognize that the system and method of the present invention may be used in many other applications. The present invention is intended to cover all alternatives, modifications and equivalents within the spirit and scope of invention, which is defined by the apprehended claims.

The technical scheme in the embodiment of the present invention will be described clearly and completely by reference to the accompanying drawings.

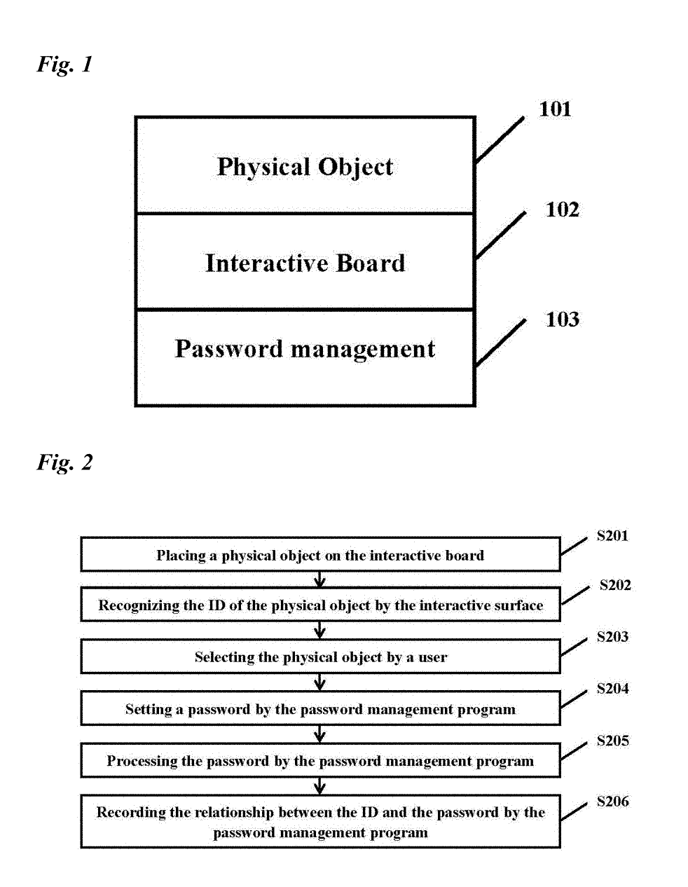

The following embodiment of the present invention provides a system for managing password for a physical object on an interactive board. FIG. 1 is an exemplary schematic diagram illustrating the system of this embodiment. The password management system includes a plurality of physical objects 101, an interactive board 102, and a password management program 103. The interactive board 102 further includes a processor that is operatively linked to the password management program 103. The password management program 103 is configured to set password, change password and recover password. Once a user reproduces the correct password, the processor is configured to send instructions to activate the functional attribute of the physical object 101. The system further includes a feedback device, and the processor is configured to instruct the feedback device to produce a feedback to indicate whether a user has reproduced the password correctly or not.

Each physical object 101 has an ID that is embedded in a passive RFID tag. The physical object 101 can be a token, an icon, a card, a figurine, or a robot.

The interactive board 102 shown in FIG. 1 includes an electrode array that comprises at least one electrode and an RF antenna array that comprises at least one RF antenna. In this embodiment, the electrode refers to metal electrode, such as iron and copper. The physical object 101 is made up of materials that can be capacitively coupled with the electrode. The interactive board 102 derives the location of the physical object 101 by detecting the magnitude of capacitive coupling between the physical object 101 on the interactive board 102 and the electrodes of the interactive board 102. The interactive board 102 can further determines the ID of the physical object 101 via the wireless communication between the RFID tag of the physical object 101 on the interactive board and the RF antennas of the interactive board 102.

FIG. 2 is an exemplary schematic diagram illustrating the working process of a system for managing password for a physical object on the interactive board in accordance with one embodiment of the present invention.

Step 1: placing a plurality of physical objects 101 on the interactive board 102, as seen in S201 in FIG. 2.

Step 2: recognizing the ID of the physical object 101 by the interactive surface, as seen in S202 in FIG. 2.

Step 3: selecting the physical object by a user, as seen in S203 in FIG. 2. The user may select the physical object by a touch gesture or by a voice command. If the user selects the physical object 101 by a touch gesture, the finger touches the physical object 101, and thus the magnitude of the capacitive coupling between the physical object 101 and the interactive board 102 changes. The processor detects the change, and then recognizes the touch gesture. The password management program 103 can capture voices, which enables the user to select the physical object by the voice command.

Step 4: setting a password for the physical object 101 by the password management program 103, as seen in S204 in FIG. 2. The password management program sets the password by touch gestures on the interactive board, keys entered on the interactive board, or voice command of the user. Once the finger touches the interactive board 102, the magnitude of the capacitance coupling between the finger and the interactive board 102 changes. The processor detects the change, and then recognizes the touch gesture. The interactive board may be further covered by a physical sheet printed with letters and numbers. If the user touches the physical sheet and enters keys, the magnitude of the capacitance coupling between the finger and the interactive board 102 changes. The processor detects the changes, and then recognizes the entered keys entered on the interactive board. The password management program 103 also has voice capture function, which enables it to obtain the voice command of the user.

Step 5: processing the password by the password management program 103, as seen in S205 in FIG. 2.

Step 6: recording the relationship between the ID of the physical object and the password by the password management program, as seen in S206 in FIG. 2.

The user sets password for a physical object 101 through the password management program 103, which enhances the safety of the device. The interactive board 102 can be covered by various physical sheets, in conjunction with different physical objects 101, serving for a variety of purposes such as interactive games, physical programming, music composition, and language learning. The user sets passwords for different physical objects 101, and the corresponding physical object 101 can be used only if the user reproduces the correct password, which meets the personal demand of the user.

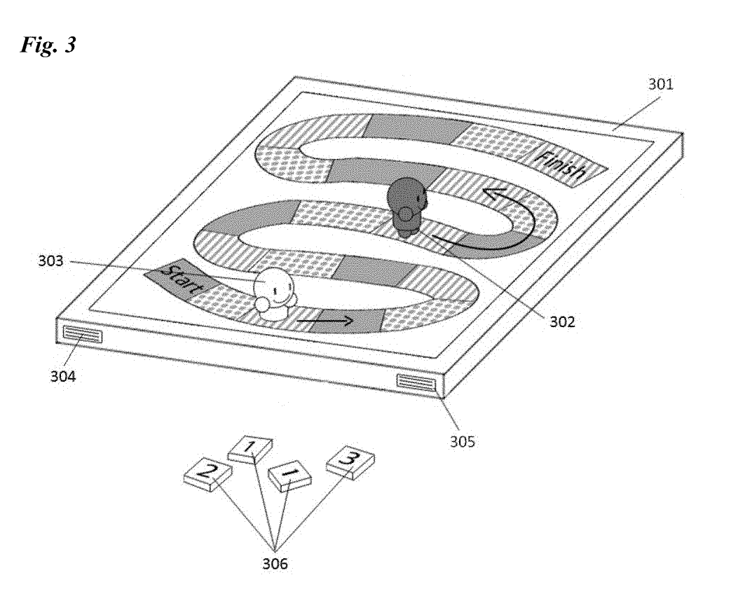

FIG. 3 is an exemplary schematic diagram illustrating the system for managing password in which the physical object is a robot in accordance with another embodiment of the present invention. The interactive board 301 is covered by a physical sheet printed with a racing game “Candyland”. The players of the game do not have to read, but need minimal counting skill, which makes the game a perfect fit for children. During the game, players only need to follow instructions, and thus do not to make any choices. In this embodiment, the player's robot 303 plays against a computerized opponent's robot 302.

The player's robot 303 and the computerized opponent's robot 302 are placed on the interactive board 301, which recognizes the ID of the player's robot 303 and the computerized opponent's robot 302. Once the player selects his/her robot 303 by touching, the password management program 304 obtains the password from the voice command of the player, processes the password, and records the relationship between the ID of object 303 and the password. When the player reproduces the correct password, the processor 305 activates a functional attribute of the player's robot 303, i.e., the player's robot 303 can move. As the player's robot 303 and the computerized opponent's robot 302 are placed in the “start” spot, the game kicks off. The player may randomly pick a card 306, which determines the number of steps that the player's robot 303 can proceed along its path, and then move the robot 303 in accordance with the number. After the robot 303 is moved by the player, the computerized opponent's robot 302 starts moving by a random number of steps as well. And this board game can be played until the winner reaches the “end” spot.

In this embodiment of the present invention, besides touching the player's robot 303, the player can also make use of the voice command to select the robot 303. The password management program 304 sets the password through touch gestures on the interactive board 301, keys entered on the interactive board 301, or voice commands.

In this embodiment of the present invention, the player sets password to the robot 303 through the password management program 304, which enhances the safety of the device and meets the personalized demand of the player.

1. A system for managing password for a physical object on an interactive board, comprising:
a plurality of physical objects, each associated with an ID that is recognized by the interactive board upon the physical object having been placed on the interactive board,
a processor that is operatively linked to the interactive board,
a password management program that runs on the processor and manages password corresponding to an ID of a physical object,
wherein, upon a user selecting a physical object among a plurality of physical objects on the interactive board, and setting a password for the physical object, the processor is configured to instruct the program to record the relationship between the ID of the physical object and the password.

2. The password managing system of claim 1, wherein the ID is embedded in a passive RFID tag.

3. The password managing system of claim 2, wherein the interactive board comprises an electrode array and an RF antenna array, and wherein the electrode array comprises at least one electrode and the RF antenna array comprises at least one RF antenna.

4. The password managing system of claim 1, wherein the user sets the password through one of the following three means: touch gestures on the interactive board, keys entered on the interactive board, and voice command of the user.

5. The password managing system of claim 1, wherein the user selects a physical object through one of the following two means: user selects a physical object by a touch gesture, and user selects a physical object by a voice command.

6. The password managing system of claim 1, upon a user reproducing the correct password, the processor is configured to activate a functional attribute of the physical object.

7. The password managing system of claim 1, wherein a physical object is selected from a group consisting of a token, an icon, a card, a figurine and a robot.

8. The password managing system of claim 1, wherein the program further comprises the functionality of changing password and recovering password.

9. The password managing system of claim 1, wherein the system further comprises a feedback device, and the processor is configured to instruct the feedback device to produce a feedback to indicate whether a user has reproduced the password correctly or not.

10. A method for managing password for a physical object on an interactive board, comprising:
placing, on the interactive board, a physical object among a plurality of physical objects, each comprising an ID,
recognizing the ID of the physical object by the interactive surface,
selecting, by a user, a physical object,
setting, by the user, a password for the physical object,
recording, by a password management program, the relationship between the ID of the physical object and the password, as instructed by a processor that is operatively linked to the interactive board.

11. The method for managing password of claim 10, wherein the ID is embedded in a passive RFID tag.

12. The method for managing password of claim 11, wherein the interactive board comprises an electrode array and an RF antenna array, and wherein the electrode array comprises at least one electrode and the RF antenna array comprises at least one RF antenna.

13. The method for managing password of claim 10, wherein the user sets the password through one of the following three means: touch gestures on the interactive board, keys entered on the interactive board, and voice command of the user.

14. The method for managing password of claim 10, wherein the user selects a physical object through one of the following two means: user selects a physical object by touch gesture, and user selects a physical object by a voice command.

15. The method for managing password of claim 10, further comprising, reproducing the correct password by the user, and activating a functional attribute of the physical object by the processor.

16. The method for managing password of claim 10, wherein a physical object is selected from a group consisting of a token, an icon, a card, a figurine and a robot.

17. The method for managing password of claim 10, further comprising, changing password and recovering password.

18. The method for managing password of claim 10, further comprising, producing a feedback to indicate whether a user has reproduced the password correctly or not, by a feedback device that is operatively linked to the processor.
